(19) United States
(12) Patent Application Publication
(10) Pub. No.: US 2025/0091482 A1
(43) Pub. Date: Mar. 20, 2025

(54) FUEL CELL VEHICLE, A METHOD OF CONTROLLING STARTUP THEREOF, AND A RECORDING MEDIUM STORING A PROGRAM TO EXECUTE THE METHOD

(71) Applicants: HYUNDAI MOTOR COMPANY, Seoul (KR); KIA CORPORATION, Seoul (KR)

(72) Inventors: Yoon Tae Kim, Hwaseong-si (KR); Sae Kwon Chang, Hwaseong-si (KR); Woo Young Lee, Hwaseong-si (KR)

(73) Assignees: HYUNDAI MOTOR COMPANY, Seoul (KR); KIA CORPORATION, Seoul (KR)

(21) Appl. No.: 18/887,507

(22) Filed: Sep. 17, 2024

(30) Foreign Application Priority Data
Sep. 18, 2023 (KR) 10-2023-0124186

(51) Int. Cl. B60L 58/31; B60L 50/75; B60L 53/20; H02M 1/34; H02M 3/156

(52) U.S. Cl. CPC B60L 58/31; B60L 50/75; B60L 53/20; H02M 1/342; H02M 3/156; B60L 2210/14

(57) ABSTRACT

A fuel cell vehicle includes a battery and a cell stack including a plurality of unit cells stacked one above another. The fuel cell vehicle also includes a boost converter configured to boost and output a target voltage received from the cell stack in response to a switching signal. The fuel cell vehicle further includes a switching unit configured to be switched in response to a control signal to connect an output side of the boost converter to the battery. The fuel cell vehicle additionally includes a controller configured to generate the control signal when startup of the fuel cell vehicle is requested. The controller is also configured to vary a switching frequency of the switching signal in response to a difference between a first voltage output from the cell stack and a second voltage of the battery.

### CROSS-REFERENCE TO RELATED APPLICATION

This application claims the benefit of and priority to Korean Patent Application No. 10-2023-0124186, filed on Sep. 18, 2023, the entire contents of which are hereby incorporated herein by reference.

### BACKGROUND

### Technical Field

The present disclosure relates to a fuel cell vehicle, a method of controlling startup thereof, and a recording medium storing a program to execute the method.

### Discussion of the Related Art

In a vehicle equipped with a fuel cell including a cell stack, a battery or a supercapacitor is charged with power generated in the fuel cell. A load of the fuel cell vehicle, such as a motor, is driven using power stored in the battery or the supercapacitor.

In general, a fuel cell vehicle includes a boost converter that boosts a stack voltage generated in a fuel cell and a battery. When a difference in voltage between an input side of the boost converter and an output side of the boost converter is small, overcurrent may result, which may damage the boost converter.

### SUMMARY

Accordingly, embodiments of the present disclosure provide a fuel cell vehicle, a method of controlling startup thereof, and a recording medium storing a program to execute the method that substantially obviate one or more problems due to limitations and disadvantages of the related art.

Embodiments of the present disclosure provide a fuel cell vehicle capable of normally implementing startup thereof only using one boost converter, a method of controlling startup thereof, and a recording medium storing a program to execute the method.

The objects accomplished by embodiments of the present disclosure are not limited to the above-mentioned objects. Other objects not mentioned herein should be more clearly understood by those having ordinary skill in the art from the following description.

Additional advantages, objects, and features of the disclosure are set forth in part in the description which follows and in part should become more apparent to those having ordinary skill in the art from the following description or may be learned from practice of the disclosure. The objectives and other advantages of the present disclosure may be realized and attained by the structure particularly pointed out in the written description and claims hereof as well as the appended drawings.

According to an embodiment, a fuel cell vehicle is provided. The fuel cell vehicle includes a battery and a cell stack including a plurality of unit cells stacked one above another. The fuel cell vehicle also includes a boost converter configured to boost and output a target voltage received from the cell stack in response to a switching signal. The fuel cell vehicle additionally includes a switching unit configured to be switched in response to a control signal to connect an output side of the boost converter to the battery. The fuel cell vehicle further includes a controller configured to generate the control signal when startup of the fuel cell vehicle is requested. The controller is also configured to vary a switching frequency of the switching signal in response to a difference between a first voltage output from the cell stack and a second voltage of the battery.

In an example, the fuel cell vehicle may further include a load configured to be connected to the output side of the boost converter by switching operation of the switching unit.

In an example, the fuel cell vehicle may further include a peripheral auxiliary device configured to be connected to the output side of the boost converter by switching operation of the switching unit.

In an example, the controller may be configured to reduce the switching frequency when a sum of the first voltage and a minimum duty ratio voltage is equal to or greater than the second voltage. The controller may also be configured to reduce the switching frequency until a sum of the minimum duty ratio voltage corresponding to the reduced switching frequency and the first voltage becomes less than the second voltage.

In an example, the controller may be configured to restore the reduced switching frequency when a sum of the minimum duty ratio voltage corresponding to the switching frequency before reduction and the first voltage becomes less than the second voltage.

In an example, the minimum duty ratio voltage may be calculated as according to

$$V D MIN = V I MAX \times \frac{DMIN}{( 1 - DMIN )} ,$$

where VDMIN represents the minimum duty ratio voltage, VIMAX represents a maximum value of the first voltage, and DMIN represents a minimum duty ratio.

In an example, the minimum duty ratio may be calculated according to

$$DMIN = T \times F \times 100 ,$$

where T represents a minimum delay time of the boost converter, and F represents the switching frequency.

In an example, the controller may be configured to generate the switching signal in a pulse width modulation manner.

In an example, the boost converter may include a first capacitor connected between a first output terminal of a positive-electrode side of the cell stack and a second output terminal of a negative-electrode side of the cell stack. The boost converter may also include an inductor including an end connected to the first output terminal. The boost converter may additionally include a diode including an anode connected to the other end of the inductor. The boost converter may further include a second capacitor disposed between a cathode of the diode and the second output terminal. The boost converter may additionally include a semiconductor switch configured to be switched in response to the switching signal and connected between the anode of the diode and the second output terminal.

In an example, T may correspond to a turn-on time of the semiconductor switch.

According to another embodiment, a method of controlling startup of a fuel cell vehicle is provided. The fuel cell vehicle includes a battery, a cell stack including a plurality of unit cells stacked one above another, and a boost converter configured to boost and output a target voltage received from the cell stack in response to a switching signal. The method includes connecting an output side of the boost converter to the battery when startup of the fuel cell vehicle is requested. The method also includes operating the boost converter to receive the target voltage from the cell stack. The method further includes adjusting a switching frequency of the switching signal in response to a difference between a first voltage output from the cell stack and a second voltage of the battery.

In an example, adjusting the switching frequency may include, when a sum of the first voltage and a minimum duty ratio voltage is equal to or greater than the second voltage, reducing the switching frequency until the sum becomes less than the second voltage.

In an example, the method may further include receiving, by the boost converter, the target voltage when a sum of the minimum duty ratio voltage corresponding to the reduced switching frequency and the first voltage becomes less than the second voltage. The method may further include restoring the reduced switching frequency when a sum of the minimum duty ratio voltage corresponding to the switching frequency before reduction and the first voltage becomes less than the second voltage. The method may additionally include receiving, by the boost converter, the target voltage from the cell stack.

According to still another embodiment, a recording medium storing a program is provided. The program may be configured to execute a method of controlling startup of a fuel cell vehicle, which includes a battery, a cell stack including a plurality of unit cells stacked one above another, and a boost converter configured to boost and output a target voltage received from the cell stack in response to a switching signal. The program, when executed by one or more processor, may cause the one or more processors to implement a function of connecting an output side of the boost converter to the battery when startup of the fuel cell vehicle is requested, a function of operating the boost converter to receive the target voltage from the cell stack, and a function of adjusting a switching frequency of the switching signal in response to a difference between a first voltage output from the cell stack and a second voltage of the battery.

It should be understood that both the foregoing general description and the following detailed description of the present disclosure are illustrative and explanatory. The foregoing general description and the following detailed description of embodiments of the present disclosure are intended to provide further explanation of the disclosure as claimed.

### BRIEF DESCRIPTION OF THE DRAWINGS

The accompanying drawings are included to enable a further understanding of embodiments of the present disclosure and are incorporated in and constitute a part of this application. The drawings illustrate embodiments of the disclosure and together with the description serve to explain the principles of the disclosure. In the drawings:

FIG. 1 is a block diagram of a fuel cell vehicle according to an embodiment;

FIG. 2 is a circuit diagram of an embodiment of the boost converter shown in FIG. 1;

FIG. 3 is a flowchart for explaining a startup control method according to an embodiment; and

FIG. 4 is a block diagram of a fuel cell vehicle according to a comparative example.

### DETAILED DESCRIPTION

The present disclosure are described more fully hereinafter with reference to the accompanying drawings, in which various embodiments are shown. The examples, however, may be embodied in many different forms, and should not be construed as being limited to the embodiments set forth herein. Rather, these embodiments are provided to make the disclosure more thorough and complete and to more fully convey the scope of the disclosure to those having ordinary skill in the art.

It should be understood that when an element is referred to as being “on” or “under” another element, the element may be directly on/under the other element, or one or more intervening elements may also be present.

When an element is referred to as being “on” or “under”, this may mean “under the element” as well as “on the element” as appropriate based on the element.

In addition, relational terms, such as “first”, “second”, “on/upper part/above”, and “under/lower part/below”, are used only to distinguish one subject or element from another subject or element, without necessarily requiring or involving any physical or logical relationship or sequence between the subjects or elements.

When a component, device, element, or the like of the present disclosure is described as having a purpose or performing an operation, function, or the like, the component, device, or element should be considered herein as being “configured to” meet that purpose or perform that operation or function.

Hereinafter, a vehicle including a fuel cell (sometimes referred to herein as a “fuel cell vehicle”) according to an embodiment is described with reference to the accompanying drawings.

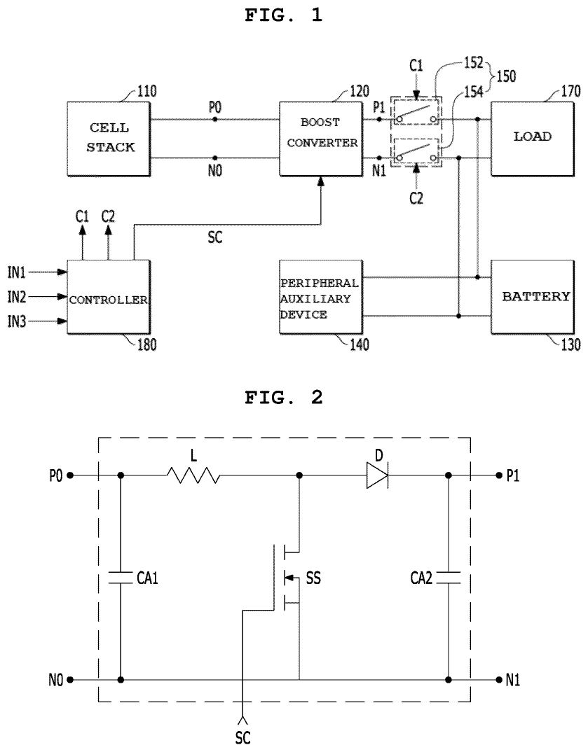

FIG. 1 is a block diagram of a fuel cell vehicle 100 according to an embodiment.

The fuel cell vehicle 100 may include a cell stack 110, a boost converter 120, a battery (or high-voltage battery) 130, a switching unit 150, and a controller 180. The fuel cell vehicle 100 may further include a load 170. In addition, the fuel cell vehicle 100 may include a peripheral auxiliary device (balance-of-plant (BOP)) 140.

An example of a fuel cell that may be included in the fuel cell vehicle 100, according to an embodiment, is briefly described below. However, the present disclosure is not limited to any specific form of fuel cell included in the fuel cell vehicle 100.

The fuel cell may be a polymer electrolyte membrane fuel cell (or proton exchange membrane fuel cell) (PEMFC), which has been studied most extensively as a power source for driving vehicles. The fuel cell may include a cell stack 110.

The cell stack 110 may include a plurality of unit cells. The plurality of unit cells may be stacked one above another in a first direction. The number of unit cells may be determined depending on the intensity of the power that is to be generated in the fuel cell.

The first direction may be, for example, a travel direction of the fuel cell vehicle 100. As another example, the first direction may be a direction intersecting the travel direction of the fuel cell vehicle 100.

A voltage VS generated and output from the cell stack 110 (hereinafter referred to as a “stack voltage” or a “first voltage”) corresponds to a potential difference between an output terminal PO of a positive-electrode side of the cell stack 110 (hereinafter referred to as a “first output terminal”) and an output terminal NO of a negative-electrode side of the cell stack 110 (hereinafter referred to as a “second output terminal”).

The boost converter 120 may be a type of DC/DC converter that converts a DC-type input voltage into a DC-type output voltage having a level higher than the level of the DC-type input voltage. The boost converter 120 may boost the output from the cell stack 110 and may output the same. For example, the output voltage VO of the boost converter 120 may be expressed using Equation 1 below.

$$V O = V I \times R \qquad [ Equation 1 ]$$

In Equation 1, VI represents the input voltage of the boost converter 120 and R represents the boosting ratio of the boost converter 120.

In Equation 1, the output voltage VO is a fixed value. Accordingly, when the input voltage VI decreases, the boosting ratio R increases, and when the input voltage VI increases, the boosting ratio R decreases.

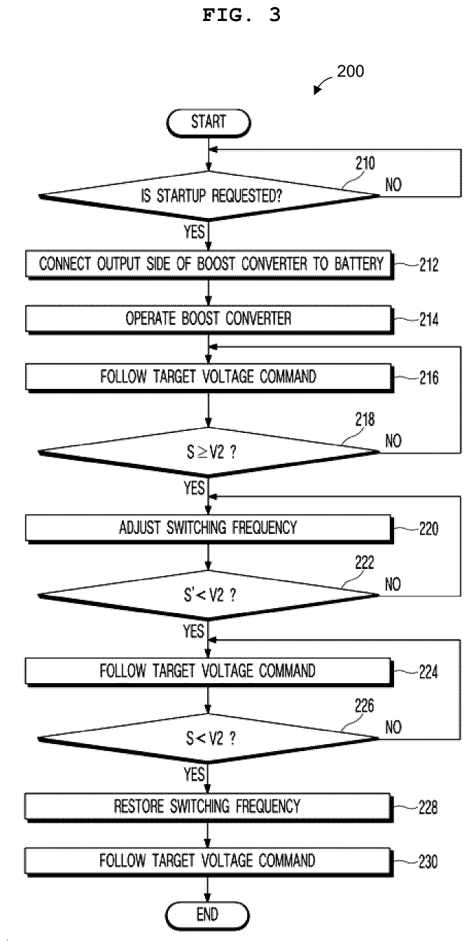

For example, referring to FIG. 1, the boost converter 120 may receive a target voltage VT from the cell stack 110. The boost converter 120 may boost and output the target voltage VT received from the cell stack 110. As used herein, extracting target voltage VT may mean extracting an amount of energy equivalent to the target voltage. In an example, extracting the target voltage VT may refer to a target voltage command following operation performed in operations 216, 224, and 230 shown in FIG. 3 as described in more detail below. In an example, the boost converter 120 may continuously extract energy from the cell stack 110 until an amount of energy equivalent to the target voltage VT is input from the cell stack 110 to the boost converter 120. Here, the target voltage VT may be a voltage on the input side of the boost converter 120. The boost converter 120 may extract an amount of energy equivalent to the target voltage VT from the cell stack 110 in response to a switching signal SC output from the controller 180. The voltage output from the boost converter 120 corresponds to a potential difference between an output terminal P1 of a positive-electrode side thereof (hereinafter referred to as a “third output terminal”) and an output terminal Ni of a negative-electrode side thereof (hereinafter referred to as a “fourth output terminal”).

The cell stack 110 may be a passive device that provides an amount of energy equivalent to the target voltage VT required for the boost converter 120 at the request of the boost converter 120.

However, the present disclosure is not limited to any specific operation of the boost converter 120. In various examples, the boost converter 120 shown in FIG. 1 may perform a function corresponding to that of a DC/DC converter that is generally used in a fuel cell vehicle.

FIG. 2 is a circuit diagram of an embodiment of the boost converter 120 shown in FIG. 1.

The boost converter 120 shown in FIG. 1 is not limited to the embodiment shown in FIG. 2.

The boost converter 120 shown in FIG. 2 may include first and second capacitors CA1 and CA2, an inductor L, a diode D, and a semiconductor switch SS.

The first capacitor CA1 may be disposed between the first output terminal PO of the cell stack 110 and the second output terminal NO of the cell stack 110.

The inductor L includes an end connected to the first output terminal PO of the cell stack 110 and another end connected to a positive electrode or an anode of the diode D. Accordingly, the inductor L is disposed between the first output terminal PO of the cell stack 110 and a positive electrode or an anode of the diode D.

The diode D includes a positive electrode or an anode connected to the other end of the inductor L.

The second capacitor CA2 may be disposed between a negative electrode or a cathode of the diode D and the second output terminal NO of the cell stack 110.

The first and second capacitors CA1 and CA2 are smoothing capacitors.

The semiconductor switch SS may be switched on (or turned on) or switched off (or turned off) in response to the switching signal SC, and may be connected between the positive electrode or an anode of the diode D and the second output terminal NO of the cell stack 110.

The semiconductor switch SS may be implemented as an insulated gate bipolar transistor (IGBT) or a field effect transistor (FET). For example, as illustrated in FIG. 2, the semiconductor switch SS may be implemented as a transistor. The transistor may include a gate G connected to the switching signal SC, a drain D connected to the positive electrode or the anode of the diode D, and a source S connected to the second output terminal NO of the cell stack 110.

The operation of the boost converter configured as described above, according to an embodiment, is described in more detail below.

The transistor, which is the semiconductor switch SS, may be turned on in response to the switching signal SC output from the controller 180. The transistor may receive the target voltage from the cell stack 110. Receiving the target voltage may mean receiving an amount of energy equivalent to the target voltage.

The cell stack 110 may serve to generate main power necessary for the fuel cell vehicle 100. Further, the battery 130 may serve to generate auxiliary power necessary for the fuel cell vehicle 100. Therefore, energy stored in the battery 130 may be provided as auxiliary power to the load 170.

The switching unit 150 includes a side connected to the boost converter 120 and another side connected to the battery 130. The switching unit 150 is switched on (or turned on) or switched off (or turned off) in response to control signals C1 and C2. When the switching unit 150 is turned on, the output side of the boost converter 120 may be connected to the battery 130, the load 170, and the peripheral auxiliary device 140.

In an embodiment, the switching unit 150 may include first and second switches 152 and 154. The first switch 152 is connected between the third output terminal P1 of the positive-electrode side of the boost converter 120 and the input terminal of the positive-electrode side of the battery 130. The first switch 152 performs switching operation in response to the first control signal C1. The second switch 154 is connected between the fourth output terminal Ni of the negative-electrode side of the boost converter 120 and the input terminal of the negative-electrode side of the battery 130. The second switch 154 performs switching operation in response to the second control signal C2. The first and second control signals C1 and C2 may be generated in the controller 180.

According to an embodiment, when startup of the vehicle is requested, the controller 180 may generate the first and second control signals C1 and C2 to turn on the first and second switches 152 and 154 of the switching unit 150, thereby connecting the output side of the boost converter 120 to the battery 130.

In an embodiment, the controller 180 determines whether startup of the fuel cell vehicle 100 is requested through an input terminal IN1. For example, a start-on command may be provided to the controller 180 through the input terminal IN1. In an example, when a user desires to start the fuel cell vehicle 100, a start-on command may be generated in an interface (not shown that may be manipulated by the user. The generated start-on command may be provided to the controller 180.

In addition, when startup of the fuel cell vehicle 100 is requested, the controller 180 may generate the switching signal SC to operate the boost converter 120. According to the embodiment, when startup of the fuel cell vehicle is requested, the controller 180 may vary a switching frequency F of the switching signal SC in response to a difference between the first voltage VS output from the cell stack 110 and a voltage of the battery 130 (hereinafter referred to as a “second voltage”).

According to an embodiment, the controller 180 may generate the switching signal SC using a pulse width modulation (PWM) method. For example, the controller 180 may adjust a turn-on time T of the switch SS to adjust the duty ratio (i.e., the width of a pulse) using a PWM method, thereby controlling the amount of output from the boost converter 120.

If the switching signal SC is generated using a pulse frequency modulation (PFM) method, rather than a PWM method, in order to control the amount of output from the boost converter 120, efficiency in a high load state may be improved.

However, components for implementing a PFM method need to be additionally provided in order to convert operation using a PWM method into operation using a PFM method. Therefore, according to an embodiment, the switching signal SC is generated using a PWM method.

Hereinafter, a switching frequency F before variation is referred to as a “first switching frequency F1” or a “fundamental switching frequency”. Further, a varied switching frequency F2 is referred to as a “second switching frequency F2” or a “variable switching frequency”. In addition, a minimum duty ratio voltage VDMIN corresponding to the first switching frequency F1 is referred to as a “first minimum duty ratio voltage”. Further, a minimum duty ratio voltage VDMIN corresponding to the second switching frequency F2 is referred to as a “second minimum duty ratio voltage”. In addition, a sum of the first minimum duty ratio voltage and the first voltage VS is referred to as a “first sum S”. Further, a sum of the second minimum duty ratio voltage and the first voltage VS is referred to as a “second sum S′”.

When the first sum S is equal to or greater than the second voltage, the controller 180 may reduce the first switching frequency, and may output a switching signal SC having the second switching frequency, which is the reduced switching frequency. In an example, the controller 180 may reduce the switching frequency until the second sum S′ becomes less than the second voltage.

The minimum duty ratio voltage may be expressed using Equation 2 below.

$$V D MIN = V I MAX \times \frac{DMIN}{( 1 - DMIN )} \qquad [ Equation 2 ]$$

In Equation 2, VDMIN represents the minimum duty ratio voltage, VIMAX represents a maximum value of the first voltage VS, and DMIN represents the minimum duty ratio.

The boost converter 120 may have a minimum duty ratio due to limitations on hardware design. This minimum duty ratio may be generated due to a delay time of the switching element SS. In this case, the minimum duty ratio may be expressed using Equation 3 below.

$$D MIN = T \times F \times 100 \qquad [ Equation 3 ]$$

In Equation 3, T represents a minimum delay time (or switching delay time) of the switching element SS included in the boost converter 120 and F represents the switching frequency. The unit of DMIN is percent (%). When the boost converter 120 is implemented as shown in FIG. 2, T may correspond to a turn-on time of the semiconductor switch SS. The minimum duty ratio may correspond to a minimum duty ratio of a pulse width modulation signal that operates the boost converter 120.

If the boost converter 120 operates at the minimum duty ratio or less, a lot of noise may be generated due to the switching delay time T. Such noise may cause abnormal operation of the boost converter 120. In addition, the duty ratio and the boosting ratio R of the boost converter 120 have a relationship in which the lower the duty ratio, the lower the boosting ratio R of the boost converter 120. Therefore, when a difference between the input voltage VI and the output voltage VO of the boost converter 120 is small, the voltage to be boosted is lowered. Thus the boost converter 120 may not operate normally at the minimum duty ratio or less. Therefore, according to an embodiment, the switching frequency is temporarily lowered in order to reduce the minimum duty ratio.

Hereinafter, a minimum duty ratio obtained by substituting the first switching frequency F1 into Equation 3 is referred to as a “first minimum duty ratio”. Further, a minimum duty ratio obtained by substituting the second switching frequency F2 into Equation 3 is referred to as a “second minimum duty ratio”.

First, when the first sum S is equal to or greater than the second voltage, the controller 180 reduces the switching frequency F. For example, the controller 180 reduces the frequency of the switching signal SC from the first switching frequency F1 to the second switching frequency F2.

Thereafter, when the second sum S′ becomes less than the second voltage, the reduced second switching frequency is restored (or returned) to the first switching frequency F1.

The controller 180 may receive the first voltage VS or a value for calculation of the first voltage VS through the input terminal IN2. The controller 180 may also receive the second voltage or a value for calculation of the second voltage through the input terminal IN3.

In examples, after startup is completed, the switching unit 150 is maintained in the turned-on state. Accordingly, the output from the boost converter 120 may be provided to the load 170, the battery 130, or the peripheral auxiliary device 140 that assists in operation of the cell stack 110 (e.g., that is necessary to drive the cell stack 110). The peripheral auxiliary device 140 may be connected to the output side of the boost converter 120 through the switching operation of the switching unit 150.

The load 170 may be connected to a main path formed by the switching unit 150 to receive the output from the boost converter 120. For example, the load 170 may be connected to the output side of the boost converter 120 through the switching operation of the switching unit 150. Alternatively, the load 170 may receive the second voltage charged in the battery 130 regardless of whether the switching unit 150 forms the main path.

In an example, the load 170 may include an inverter (not shown) and a motor (not shown).

The inverter may be connected to the third output terminal P1 and the fourth output terminal Ni of the boost converter 120. The inverter may convert the received DC-type voltage or the DC-type second voltage stored in the battery 130 into an AC-type voltage depending on the driving state of the fuel cell vehicle 100, and may output the AC-type voltage to the motor.

The motor may be driven in response to the AC-type voltage output from the inverter. For example, the motor may rotate upon receiving the AC voltage for the motor from the inverter, and thus may serve to drive the fuel cell vehicle 100. In an example, the motor may be a three-phase AC rotating device including a rotor in which a permanent magnet is embedded. However, the present disclosure is not limited to any specific form of the motor.

In addition, although not shown, the load 170 of the fuel cell vehicle 100 may include parts necessary to drive the vehicle, such as a motor-driven power steering (MDPS) device, a radiator fan, and headlights. These various parts included in the load 170 may be driven upon receiving the voltage output from the boost converter 120 or the second voltage stored in the battery 130 as a driving voltage.

Hereinafter, a method of controlling startup of a fuel cell vehicle, according to an embodiment, is described with reference to FIGS. 1 and 3. However, the present disclosure is not limited to what is shown in FIGS. 1 and 3.

Further, a startup control method 200 according to the embodiment shown in FIG. 3 may be performed by the fuel cell vehicle 100 shown in FIG. 1. However, the present disclosure is not limited thereto. For example, according to another embodiment, the startup control method 200 according to the embodiment shown in FIG. 3 may be performed by a fuel cell vehicle configured differently from the fuel cell vehicle 100 shown in FIG. 1.

In an embodiment, the fuel cell vehicle 100 (e.g., the controller 180) shown in FIG. 1 may perform the startup control method 200 according to the embodiment shown in FIG. 3. However, the present disclosure is not limited thereto. For example, according to another embodiment, the fuel cell vehicle 100 shown in FIG. 1 may perform a startup control method configured differently from the startup control method 200 according to the embodiment shown in FIG. 3.

FIG. 3 is a flowchart of the startup control method 200 according to an embodiment.

In a step or operation 210, a determination is made as to whether startup of the fuel cell vehicle 100 is requested.

When startup of the fuel cell vehicle 100 is requested, the boost converter 120 is connected to the battery 130 in a step or operation 212. In an embodiment, to connect the boost converter 120 to the battery 130, the controller 180 may turn on the switching unit 150 using the first and second control signals C1 and C2.

In a step or operation 214, the controller 180 generates a switching signal SC to operate the boost converter 120.

In a step or operation 216, the controller 180 controls the boost converter 120 to follow a target voltage command. For example, under the control of the controller 180, the boost converter 120 may receive a target voltage VT from the cell stack 110, may boost the target voltage, and may output the boosted target voltage. In order to perform the step or operation 216, the switching signal SC output from the controller 180 to the boost converter 120 has a first switching frequency.

In steps or operations 218 and 220, the controller 180 adjusts the switching frequency of the switching signal SC in response to a difference between the first voltage VS output from the cell stack 110 and the second voltage of the battery 130.

For example, in the step or operation 218, the controller 180 determines whether the first sum S of the first voltage and the first minimum duty ratio voltage is equal to or greater than the second voltage. When the first sum S is not equal to or greater than the second voltage, the controller 180 proceeds to the step or operation 216 to follow the target voltage command.

On the other hand, when the first sum S is equal to or greater than the second voltage, it becomes difficult for the boost converter 120 to operate normally. Accordingly, the switching frequency of the switching signal SC is adjusted in the step or operation 220. For example, the minimum duty ratio may be reduced by reducing the switching frequency, and the minimum duty ratio voltage may be reduced by reducing the minimum duty ratio.

In the fuel cell vehicle 100, the cell stack 110 and the battery 130 have different voltage ranges from each other. Thus, the boost converter 120 is used. In a special situation such as cold shut down (CSD), a voltage difference between the cell stack 110 and the battery 130 may be less than the minimum duty ratio voltage VDMIN of the boost converter 120 expressed using Equation 2 above. In this case, the switching noise of the boost converter 120 may become severe, which may cause abnormal operation of the boost converter 120. Therefore, in order to avoid this problem, in a situation in which the difference between the input voltage VI and the output voltage VO of the boost converter 120 is small, e.g., in a situation in which the first sum S is equal to or greater than the second voltage V2, the switching frequency F shown in Equation 3 above is temporarily reduced from the first switching frequency to the second switching frequency. When the switching frequency F is reduced, the minimum duty ratio DMIN is reduced as shown in Equation 3 above. Further, when the minimum duty ratio DMIN is reduced, the minimum duty ratio voltage VDMIN is reduced as shown in Equation 2 above. As a result, the boost converter 120 may operate normally.

The above-mentioned CSD may refer to operation of safely stopping (S/D) the fuel cell system including the cell stack 110 through additional post-processing using a compressor in order to prevent a problem in which internal condensed water freezes when stopping the fuel cell vehicle in a cold shut down situation.

In a step or operation 222, the controller 180 determines whether the second sum S′ is less than the second voltage. When the second sum S′ is not less than the second voltage, the controller 180 proceeds to the step or operation 220 to further reduce the switching frequency. Accordingly, the controller 180 reduces the switching frequency until the second sum S′ becomes less than the second voltage.

When the second sum S′ is less than the second voltage, the controller 180 controls the boost converter 120 to follow the target voltage command in a step or operation 224. In order to perform the step or operation 224, the switching signal SC output to the boost converter 120 has a second switching frequency.

In a step or operation 226, the controller 180 determines whether the first sum S is less than the second voltage V2. When the first sum S is not less than (i.e., is greater than or equal to) the second voltage V2, the process proceeds to the step or operation 224.

On the other hand, when the first sum S is less than the second voltage V2, the controller 180 restores the switching frequency in a step or operation 228. For example, the controller 180 restores the switching frequency in a manner of increasing the switching frequency from the second switching frequency to the first switching frequency.

In an embodiment, the reason for restoring the switching frequency is to enable the boost converter 120 to operate at as high a switching frequency as possible because the efficiency of the boost converter 120 decreases in a high load region at a low switching frequency.

In a step or operation 230, the controller 180 controls the boost converter 120 to follow the target voltage command to complete startup. In order to perform the step or operation 230, the switching signal SC output to the boost converter 120 has the first switching frequency.

Even after startup is completed, the switching unit 150 may be maintained in an on state, and thus the output from the boost converter 120 may be supplied to the load 170.

Hereinafter, to enable better understanding of the method 200 shown in FIG. 3, an example is provided in which the first voltage VS of the cell stack 110 is 350 V to 600 V, the second voltage is 630 V to 800 V, the first switching frequency is 25 kHz, the first minimum duty ratio at the first switching frequency is 10%, the switching delay time T is 4 milliseconds (ms), and the second switching frequency is 10 kilohertz (kHz).

When these conditions are substituted into Equation 2, the first minimum duty ratio voltage at the first switching frequency is calculated to be 66.66 V, as shown in Equation 4 below.

$$V D MIN = Maximum Value of First Voltage \times First Minimum Duty Ratio / ( 1 - First Minimum Duty Ratio ) = 600 \times 0.1 / ( 1 - 0.1 ) = 600 \times 0.1 / 0.9 \qquad [ Equation 4 ]$$

Accordingly, the minimum value of the second voltage for normal operation of the boost converter 120 is expressed using Equation 5 below.

$$Second Voltage = First Voltage + Minimum Duty Ratio Voltage = 600 + 66.66 = 666.66 \qquad [ Equation 5 ]$$

Considering a margin, the minimum value of the second voltage needs to be 670 V or higher.

In this case, according to the embodiment, when the second voltage becomes 670 V or lower in step 218, the first switching frequency of 25 kHz is reduced to the second switching frequency of 10 kHz. Thus, the first minimum duty ratio is reduced to the second minimum duty ratio of 4%, as shown in Equation 6 below.

$$D MIN = 4 ms \times 10 kHz \times 100 = 4 \% \qquad [ Equation 6 ]$$

If the second minimum duty ratio obtained through Equation 6 above is substituted into Equation 2 above, the second minimum duty ratio voltage is calculated to have a reduced value of 25 V, as shown in Equation 7 below.

$$V D MIN = 600 \times \frac{0.04}{( 1 - 0.04 )} = 600 \times \frac{0.04}{0.96} = 25 \qquad [ Equation 7 ]$$

Accordingly, the minimum value of the second voltage obtained through Equation 5 above is reduced to 625 V, as shown in Equation 8 below.

$$Second Voltage = First Voltage + Second Minimum Duty Ratio Voltage = 600 + 25 = 625 \qquad [ Equation 8 ]$$

referring again to FIG. 1, in various embodiments, the fuel cell vehicle 100 may include various kinds of electronic control units (ECUs). Each of the ECUs is a kind of computer storing software for implementation of various functions for the fuel cell vehicle 100. A startup control method, such as the startup control method 200 of FIG. 3, may be executed by the ECUs.

A computer-readable recording medium in which a program for executing the startup control method 200 performed by the fuel cell vehicle 100 is recorded may store a program that, when executed by one or more processors, causes the one or more processors to implement a function of connecting the output side of the boost converter 120 to the battery 130 when startup of the fuel cell vehicle 100 is requested, a function of operating the boost converter 120 to receive the target voltage from the cell stack 110, and a function of adjusting the switching frequency of the switching signal in response to a difference between the first voltage output from the cell stack 110 and the second voltage of the battery 130. The computer-readable recording medium may be read by a computer system including the one or more processors.

The computer-readable recording medium may include various kinds of storage devices in which data that may be read by a computer system is stored. Examples of the computer-readable recording medium may include ROM, RAM, CD-ROM, a magnetic tape, a floppy disk, and an optical data storage device. The computer-readable recording medium may also be distributed over network-coupled computer systems so that the computer-readable code is stored and executed in a distributed fashion. Also, functional programs, code, and code segments for accomplishing the startup control method of the present disclosure may be construed by those having ordinary skill in the art to which the present disclosure pertains.

Hereinafter, a fuel cell vehicle according to a comparative example and the fuel cell vehicle according to embodiments of the present disclosure is described.

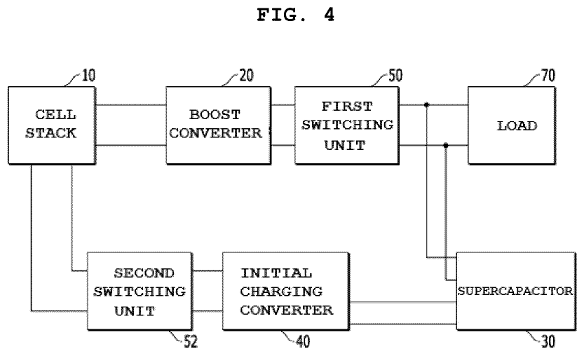

FIG. 4 is a block diagram of a fuel cell vehicle according to a comparative example.

The fuel cell vehicle according to the comparative example includes a cell stack 10, a boost converter 20, a load 70, a supercapacitor 30, an initial charging converter 40, and first and second switching units 52 and 54. The cell stack 10, the boost converter 20, the supercapacitor 30, and the load 70 may generally perform the same functions as the cell stack 110, the boost converter 120, the battery 130, and the load 170 shown in FIG. 1, respectively.

The fuel cell vehicle according to the comparative example shown in FIG. 4 uses two converters 20 and 40 to reduce the time taken to satisfy conditions under which the boost converter 20 operates normally.

To this end, the initial charging converter 40 first operates to charge the voltage of the cell stack 10 to the supercapacitor 30. When the voltage charged in the supercapacitor 30 becomes greater than the voltage of the cell stack 10, the boost converter 20 is immediately operated during operation of the initial charging converter 40, thereby solving the problem of minimum duty ratio.

However, the fuel cell vehicle according to the comparative example has a problem of requiring two converters 20 and 40.

In contrast, in the fuel cell vehicle 100 according to an embodiment, when a difference between the input voltage VI and the output voltage VO of the boost converter 120 is small, the switching frequency of the boost converter 120 is temporarily reduced to reduce the minimum duty ratio, thereby resolving a situation in which a difference between the first voltage and the second voltage is small using one boost converter 120. In other words, according to an embodiment, when a difference between the input voltage VI and the output voltage VO of the boost converter 120 is small, the switching frequency is changed to reduce the minimum duty ratio so that the boost converter 120 operates normally.

In theory, the boost converter 120 does not have a minimum duty ratio. However, the switch SS included in the actual boost converter 120 has a switching time when the switch SS is turned between on and off states. During the switching time, the boost converter 120 does not perform any other operations. This time is the switching delay time T. In other words, during a time when the switch is turned on/off, the boost converter 120 is not capable of performing a new command. Therefore, the switching delay time T is reflected in the minimum duty ratio, as shown in Equation 3 of the boost converter 120. Accordingly, in a situation in which operation of the boost converter 120 is impossible due to limitations on hardware (H/W) in a region of the minimum duty ratio or lower, embodiments of the present disclosure may overcome the limitations on hardware through the method 200 shown in FIG. 3.

As a result, according to an embodiment, even when a difference between the first voltage and the second voltage is small, operation of the boost converter 120 is possible. Further, in a special situation such as cold shut down (CSD), the boost converter 120 may be used without consideration of a voltage difference.

As described above, the minimum value of the second voltage for normal operation of the boost converter 120 may be 666.66 V. Nevertheless, if the second voltage becomes lower than 666.66 V, the boost converter 120 may not operate normally due to limitations on the first minimum duty ratio caused by the switching delay time T. Therefore, an additional converter needs to be placed on the downstream side of the boost converter 120 or the upstream side of the battery 130 in order to maintain the voltage on the upstream side of the additional converter such that the first sum S is equal to or less than the voltage on the upstream side of the additional converter.

For example, as shown in FIG. 4, the initial charging converter 40 may be placed on the upstream side of the supercapacitor 30. The initial charging converter 40 has the following two operation modes.

First, when the second voltage is 666.66 V or higher, the initial charging converter 40 is maintained in a standby state while diverting the power output from the cell stack 10. Next, when the second voltage becomes lower than 666.66 V, the initial charging converter 40 starts operation to maintain the voltage between the boost converter 20 and the initial charging converter 40 at 666.66 V or higher. To this end, the switching operations of the first and second switching units 52 and 54 may be controlled.

In contrast, according to embodiments of the present disclosure, when the minimum value of the second voltage is 666.66 V as described above, the switching frequency is changed to the second switching frequency in order to lower the minimum value of the second voltage to 625 V, with a result that the boost converter 120 is capable of operating normally at all times.

As is apparent from the above description, in a fuel cell vehicle, a method of controlling startup thereof, and a recording medium storing a program to execute methods according to embodiments of the present disclosure, since no additional converter is required, loss due to addition of a converter may be avoided. For example, a cost of manufacturing a startup control system may be reduced, a process of manufacturing the same may be simplified, and the volume thereof may be reduced. Further, since control processes are simplified, the overall efficiency of the startup control system may be improved, and packaging thereof may be improved.

However, the effects achievable through the disclosure are not limited to the above-mentioned effects. Other effects not mentioned herein should be more clearly understood by those having ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to several embodiments thereof, these embodiments are only provided for illustrative purposes. The described embodiments do not restrict the present disclosure. It should be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell vehicle, comprising:
a battery;
a cell stack including a plurality of unit cells stacked one above another;
a boost converter configured to boost and output a target voltage received from the cell stack in response to a switching signal;
a switching unit configured to be switched in response to a control signal to connect an output side of the boost converter to the battery; and
a controller configured to
generate the control signal when startup of the fuel cell vehicle is requested, and
vary a switching frequency of the switching signal in response to a difference between a first voltage output from the cell stack and a second voltage of the battery.

2. The fuel cell vehicle according to claim 1, further comprising a load configured to be connected to the output side of the boost converter by switching operation of the switching unit.

3. The fuel cell vehicle according to claim 2, further comprising a peripheral auxiliary device configured to be connected to the output side of the boost converter by switching operation of the switching unit.

4. The fuel cell vehicle according to claim 1, wherein the controller is configured to:
reduce the switching frequency when a sum of the first voltage and a minimum duty ratio voltage is equal to or greater than the second voltage; and
reduce the switching frequency until a sum of the minimum duty ratio voltage corresponding to the reduced switching frequency and the first voltage becomes less than the second voltage.

5. The fuel cell vehicle according to claim 4, wherein the controller is configured to restore the reduced switching frequency when a sum of the minimum duty ratio voltage corresponding to the switching frequency before reduction and the first voltage becomes less than the second voltage.

6. The fuel cell vehicle according to claim 4, wherein the minimum duty ratio voltage is calculated according to
$$V D MIN = V I MAX \times \frac{DMIN}{( 1 - DMIN )} ,$$
wherein
VDMIN represents the minimum duty ratio voltage,
VIMAX represents a maximum value of the first voltage, and
DMIN represents a minimum duty ratio.

7. The fuel cell vehicle according to claim 5, wherein the minimum duty ratio voltage is calculated according to
$$V D MIN = V I MAX \times \frac{DMIN}{( 1 - DMIN )} ,$$
wherein
VDMIN represents the minimum duty ratio voltage,
VIMAX represents a maximum value of the first voltage, and
DMIN represents a minimum duty ratio.

8. The fuel cell vehicle according to claim 6, wherein the minimum duty ratio is calculated according to
$$D MIN = T \times F \times 100 ,$$
wherein
T represents a minimum delay time of the boost converter, and
F represents the switching frequency.

9. The fuel cell vehicle according to claim 8, wherein the controller is configured to generate the switching signal in a pulse width modulation manner.

10. The fuel cell vehicle according to claim 9, wherein the boost converter includes:
a first capacitor connected between a first output terminal of a positive-electrode side of the cell stack and a second output terminal of a negative-electrode side of the cell stack;
an inductor including an end connected to the first output terminal;
a diode including an anode connected to another end of the inductor;
a second capacitor disposed between a cathode of the diode and the second output terminal; and
a semiconductor switch configured to be switched in response to the switching signal and connected between the anode of the diode and the second output terminal.

11. The fuel cell vehicle according to claim 10, wherein T corresponds to a turn-on time of the semiconductor switch.

12. A method of controlling startup of a fuel cell vehicle including a battery, a cell stack including a plurality of unit cells stacked one above another, and a boost converter configured to boost and output a target voltage received from the cell stack in response to a switching signal, the method comprising:
connecting an output side of the boost converter to the battery when startup of the fuel cell vehicle is requested;
operating the boost converter to receive the target voltage from the cell stack; and
adjusting a switching frequency of the switching signal in response to a difference between a first voltage output from the cell stack and a second voltage of the battery.

13. The method according to claim 12, wherein adjusting the switching frequency includes, when a sum of the first voltage and a minimum duty ratio voltage is equal to or greater than the second voltage, reducing the switching frequency until the sum becomes less than the second voltage.

14. The method according to claim 13, further comprising:
receiving, by the boost converter, the target voltage when a sum of the minimum duty ratio voltage corresponding to the reduced switching frequency and the first voltage becomes less than the second voltage;
restoring the reduced switching frequency when a sum of the minimum duty ratio voltage corresponding to the switching frequency before reduction and the first voltage becomes less than the second voltage; and
receiving, by the boost converter, the target voltage from the cell stack.

15. A computer-readable recording medium storing a program to execute a method of controlling startup of a fuel cell vehicle including a battery, a cell stack including a plurality of unit cells stacked one above another, and a boost converter configured to boost and output a target voltage received from the cell stack in response to a switching signal, the recording medium storing a program that, when executed by one or more processors, causes the one or more processors to implement:
a function of connecting an output side of the boost converter to the battery when startup of the fuel cell vehicle is requested;
a function of operating the boost converter to receive the target voltage from the cell stack; and
a function of adjusting a switching frequency of the switching signal according to a difference between a first voltage output from the cell stack and a second voltage of the battery.
